(19) United States
(12) Patent Application Publication
(10) Pub. No.: US 2026/0148903 A1
(43) Pub. Date: May 28, 2026

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/453,639

(22) Filed: Jan. 20, 2026

Related U.S. Application Data
(63) Continuation of application No. PCT/JP2024/023949, filed on Jul. 2, 2024.

(30) Foreign Application Priority Data
Aug. 2, 2023 (JP) 2023-126524

(51) Int. Cl. H01G 4/30; H01G 4/232

(52) U.S. Cl. CPC H01G 4/30; H01G 4/2325

(57) ABSTRACT

A three-terminal laminated ceramic capacitor includes a laminate including an inner layer portion including dielectric layers and internal electrodes alternately laminated, a first outer layer portion on one side in a lamination direction, a second outer layer portion on the other side, end surface external electrodes on longitudinal end surfaces of the laminate, and lateral surface external electrodes on widthwise lateral surfaces of the laminate. A dimension LC in a longitudinal direction is 0.1 mm≤LC≤0.70 mm, a dimension WC in the width direction is 0.05 mm≤WC≤0.40 mm, a dimension TC in the lamination direction is 0.10 mm≤TC≤0.55 mm, and the second outer layer portion is on a mounting surface side. A thickness of the first outer layer portion is t1, and a thickness of the second outer layer portion by t2, t2<t1 is satisfied.

### CROSS REFERENCE TO RELATED APPLICATIONS

This application claims the benefit of priority to Japanese Patent Application No. 2023-126524 filed on Aug. 2, 2023 and is a Continuation Application of PCT Application No. PCT/JP2024/023949 filed on Jul. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Recently, reduction in impedance of electronic circuit lines has become important, particularly for mobile device products. For the purpose of reducing impedance of electronic circuit lines, three-terminal multilayer ceramic capacitors for decoupling applications are widely used.

A three-terminal multilayer ceramic capacitor includes a multilayer body including an inner layer portion in which dielectric layers having end surface internal electrodes exposed at end surfaces thereon and dielectric layers having lateral surface internal electrodes exposed at lateral surfaces thereon are alternately laminated in a plurality of layers, and outer layer portions provided on one side and the other side in the lamination direction of the inner layer portion. The three-terminal multilayer ceramic capacitor includes further includes end surface external electrodes provided on the end surfaces, and lateral surface external electrodes provided on the lateral surfaces (see Japanese Unexamined Patent Application Publication No. 2013-201417).

Reduction in size of the three-terminal multilayer ceramic capacitor enables further reduction of impedance in high-frequency characteristics. The impedance reduction through a size reduction is derived from the reduction of equivalent series inductance (ESL) of the multilayer ceramic capacitor, which is caused by shortening of the current path flowing inside the multilayer ceramic capacitor.

### SUMMARY OF THE INVENTION

In recent years, multilayer ceramic capacitors have been increasingly reduced in size. When multilayer ceramic capacitors are reduced in size, the low ESL effect per unit current path length becomes greater.

Example embodiments of the present invention are provided to further reduce ESL in each of small-sized three-terminal multilayer ceramic capacitors.

A three-terminal multilayer ceramic capacitor according to an example embodiment of the present invention includes a multilayer body including an inner layer portion including a plurality of dielectric layers and a plurality of internal electrodes that are alternately laminated, and a first outer layer portion provided on one side in the lamination direction of the inner layer portion and a second outer layer portion provided on the other side in the lamination direction of the inner layer portion, end surface external electrodes each provided on a corresponding one of both end surfaces in the length direction intersecting with the lamination direction of the multilayer body, and a lateral surface external electrode provided on at least one of lateral surfaces in the width direction intersecting with the lamination direction and the length direction of the multilayer body. The multilayer ceramic capacitor includes a dimension LC in the length direction of about 0.1 mm≤LC≤about 0.70 mm or less, a dimension WC in the width direction of about 0.05 mm≤WC≤about 0.40 mm or less, and a dimension TC in the lamination direction of about 0.10 mm≤TC≤about 0.55 mm or less. The second outer layer portion corresponds to a mounting surface. When the thickness of the first outer layer portion is defined as t1 and the thickness of the second outer layer portion is defined as t2, t2<t1 is satisfied.

According to example embodiments of the present invention, it is possible to further reduce ESL in each of small-sized three-terminal multilayer ceramic capacitors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view of the multilayer ceramic capacitor 1 taken along the II-II direction in FIG. 1 in a first example embodiment of the present invention.

FIG. 3 is a cross-sectional view of the multilayer ceramic capacitor 1 taken along the III-III direction in FIG. 1 in a first example embodiment of the present invention.

FIG. 4 is a cross-sectional view along an end surface exposed internal electrode 15A of the multilayer ceramic capacitor 1.

FIG. 5 is a cross-sectional view along a lateral surface exposed internal electrode 15B of the multilayer ceramic capacitor 1.

FIG. 6 is a diagram explaining a manufacturing process of a multilayer body 2 in a method of manufacturing the multilayer ceramic capacitor 1.

FIG. 7 is a flowchart explaining a method of manufacturing the multilayer ceramic capacitor 1.

### DETAILED DESCRIPTION OF THE EXAMPLE EMBODIMENTS

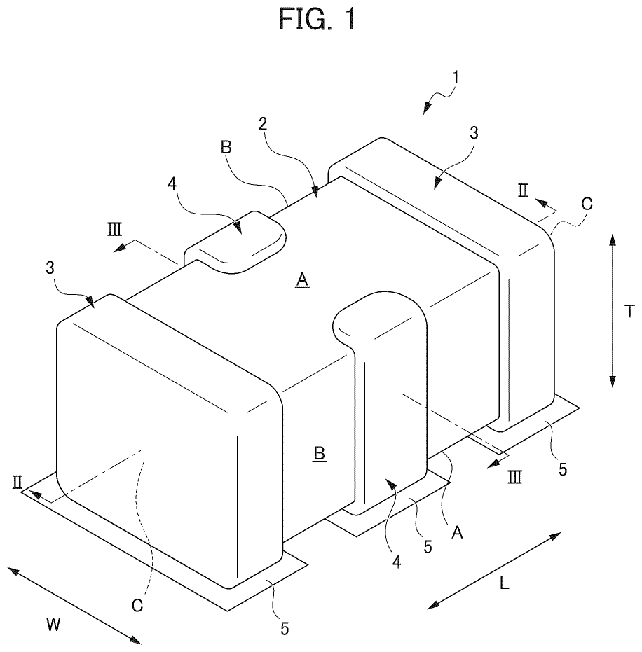

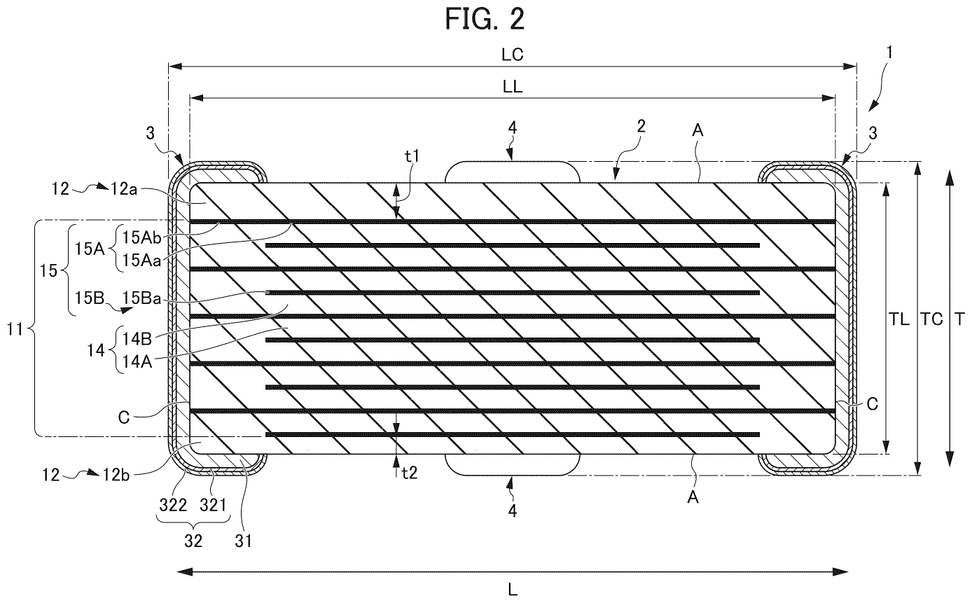

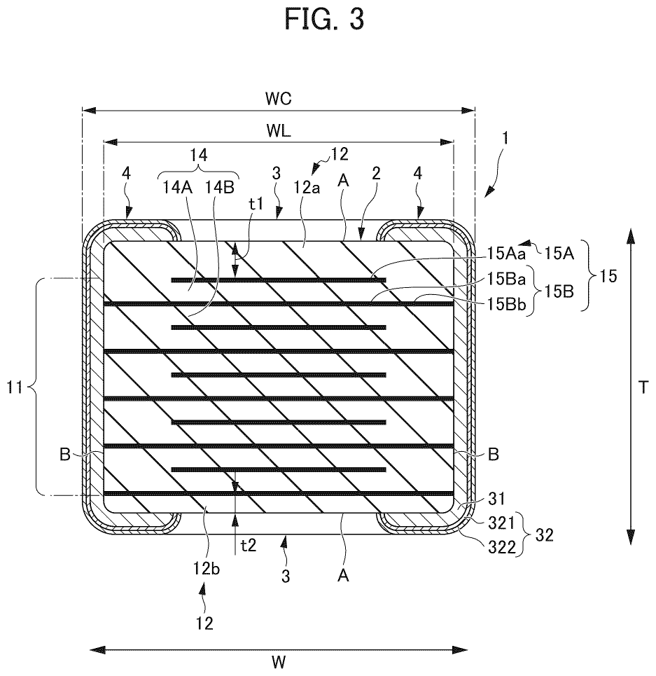

Hereinafter, multilayer ceramic capacitors according to example embodiments of the present invention will be described. FIG. 1 is a schematic perspective view of the multilayer ceramic capacitor 1. FIG. 2 is a cross-sectional view of the multilayer ceramic capacitor 1 taken along the II-II direction in FIG. 1 in a first example embodiment. FIG. 3 is a cross-sectional view of the multilayer ceramic capacitor 1 taken along the III-III direction in FIG. 1 in the first example embodiment.

The multilayer ceramic capacitor 1 is a three-terminal multilayer ceramic capacitor 1 including a multilayer body 2, end surface external electrodes 3 provided on both end surfaces C in the length direction L of the multilayer body 2, and lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms representing the orientation of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the example embodiments, the lamination direction T, the length direction L, and the width direction W are orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C.

The multilayer ceramic capacitor 1 shown in FIG. 2 or FIG. 3 has a dimension LC in the length direction L of about 0.1 mm or more and about 0.70 mm or less, a dimension WC in the width direction W of about 0.05 mm or more and about 0.40 mm or less, and a dimension TC in the lamination direction T of about 0.10 mm or more and about 0.55 mm or less, for example.

Furthermore, the capacitance of the multilayer ceramic capacitor 1 is about 0.022 μF or more and about 10 μF or less, and preferably about 1.0 μF or more and about 2.2 μF or less, for example. The ESL of the multilayer ceramic capacitor 1 is about 65 pH or less at about 100 MHz, and preferably about 50 pH or less at about 1 GHz, for example.

The capacitance of the multilayer ceramic capacitor 1 can be obtained using an LCR meter (available from Agilent Technologies, model number: E4980A) under conditions of 1 kHz and 0.5 Vrms. The ESL of the multilayer ceramic capacitor 1 can be obtained by calculation from measured values of impedance at a predetermined frequency using a network analyzer (available from Agilent Technologies, model number: E5080A).

The multilayer body 2 includes an inner layer portion 11 and outer layer portions 12 provided on both sides of the inner layer portion 11 in the lamination direction T. It is preferable that the multilayer body 2 includes rounded corner portions and ridge portions. The corner portions refer to portions where three surfaces of the multilayer body 2 intersect, and the ridge portions refer to portions where two surfaces of the multilayer body 2 intersect.

Example dimensions of the multilayer body 2 shown in FIG. 2 or FIG. 3 are as follows: the dimension LL in the length direction L is about 0.09 mm or more and about 0.69 mm or less, the dimension WL in the width direction W is about 0.04 mm or more and about 0.39 mm or less, and the dimension TL in the lamination direction T is about 0.09 mm or more and about 0.54 mm or less.

The inner layer portion 11 includes a plurality of dielectric layers 14 and a plurality of internal electrodes 15 laminated along the lamination direction T.

The dielectric layers 14 are each made of a ceramic material. As the ceramic material, a ceramic material having as a main component a ceramic material including at least one of Ca, Zr, and Ti is used. Specifically, for example, a ceramic material having a perovskite structure represented by a general formula ABO₃ including Ca and Zr is used as a main component. Examples of such ceramic materials having a perovskite structure include, but are not limited to, BaTiO₃ (barium titanate) and CaZrO₃ (calcium zirconate). Further, the main component of the ceramic material forming the dielectric layers 14 may include all of Ca, Zr, and Ti.

The internal electrodes 15 are each preferably made of a metal material such as Ni, Cu, Ag, Pd, Ag—Pd alloy, Au, or the like.

The internal electrodes 15 include a plurality of end surface exposed internal electrodes 15A and a plurality of lateral surface exposed internal electrodes 15B that are alternately provided. When it is not necessary to particularly distinguish between the end surface exposed internal electrodes 15A and the lateral surface exposed internal electrodes 15B, they are collectively described as internal electrodes 15.

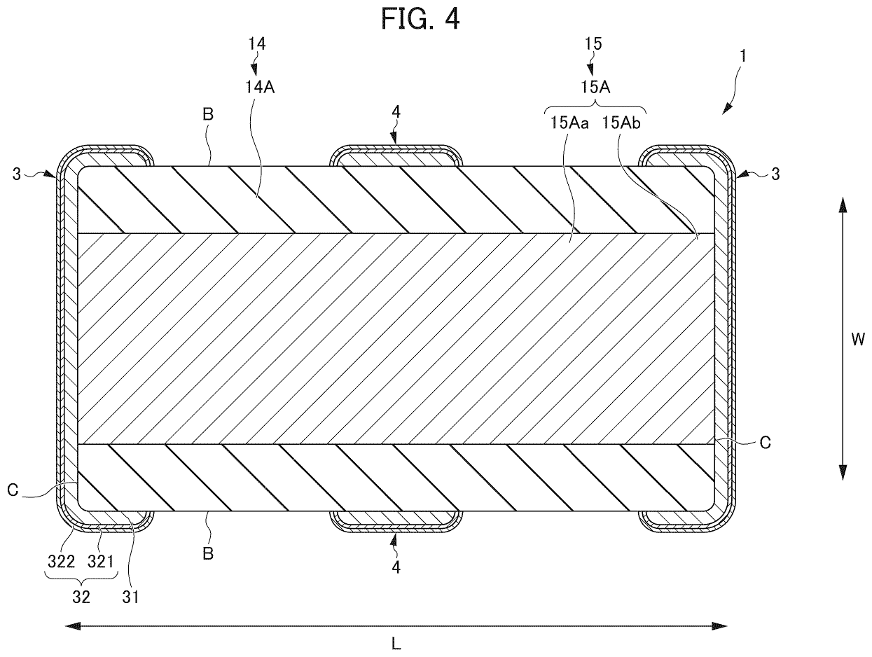

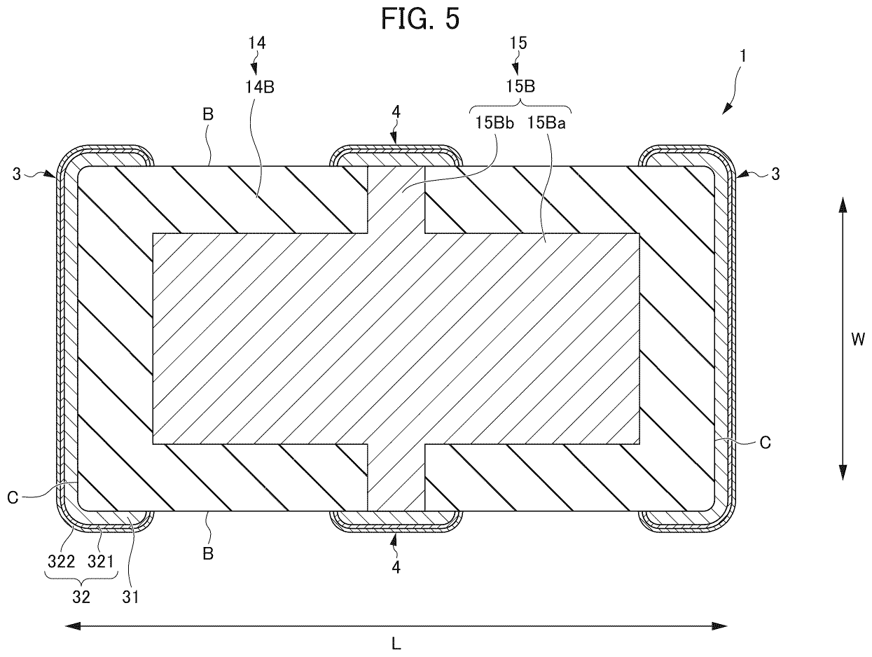

FIG. 4 is a cross-sectional view along the end surface exposed internal electrodes 15A of the multilayer ceramic capacitor 1. FIG. 5 is a cross-sectional view along the lateral surface exposed internal electrodes 15B of the multilayer ceramic capacitor 1.

As shown in FIG. 4, the end surface exposed internal electrode 15A extends between both end surfaces C in the length direction L of the multilayer body 2 and is spaced apart from both lateral surfaces B in the width direction W by a fixed distance. The end surface exposed internal electrode 15A includes an end surface counter portion 15Aa located in the middle portion between both end surfaces C, and end surface extension portions 15Ab extending from the end surface counter portion 15Aa toward both end surfaces C. In the example embodiments, the end surface counter portion 15Aa and the end surface extension portions 15Ab have equal or substantially equal dimensions in the width direction W, and the end surface exposed internal electrode 15A is substantially rectangular as a whole combining the end surface counter portion 15Aa and the end surface extension portions 15Ab. The end surface extension portions 15Ab extending from the end surface counter portion 15Aa toward both end surfaces C each extend toward both end surfaces C and are exposed at the end surfaces C of the multilayer body 2, and are connected to the end surface external electrodes 3 provided on both end surfaces C in the length direction L of the multilayer body 2.

As shown in FIG. 5, the lateral surface exposed internal electrode 15B includes a lateral surface counter portion 15Ba located in the middle between both lateral surfaces B, and lateral surface extension portions 15Bb extending from the lateral surface counter portion 15Ba toward both lateral surfaces B. The lateral surface counter portion 15Ba has a substantially rectangular shape that is slightly smaller than the multilayer body 2, and is spaced apart from both lateral surfaces B in the width direction W by a fixed distance.

The dimension of the lateral surface extension portions 15Bb in the length direction L is smaller than the dimension of the lateral surface counter portion 15Ba in the length direction L. The lateral surface extension portions 15Bb extend toward both lateral surfaces B and are exposed at the lateral surfaces B of the multilayer body 2, and are bonded to the lateral surface external electrodes 4 provided on both lateral surfaces of the multilayer body 2 in the width direction W.

The end surface counter portion 15Aa and the lateral surface counter portion 15Ba are opposed to each other to provide a capacitor portion.

The dielectric layers 14 include a plurality of first dielectric layers 14A and a plurality of second dielectric layers 14B which are alternately laminated. The end surface exposed internal electrode 15A exposed at the end surface C is provided on each of the plurality of first dielectric layers 14A, and the lateral surface exposed internal electrode 15B exposed at a portion of the lateral surface B is provided on each of the plurality of second dielectric layers 14B.

With reference to FIG. 2 and FIG. 3 again, each of the outer layer portions 12 is a dielectric layer provided adjacent to the main surface A of the inner layer portion 11. Each of the outer layer portions 12 is made of the same material as the dielectric layers 14 of the inner layer portion 11. The outer layer portions 12 include a first outer layer portion 12a provided adjacent to the first main surface A of the inner layer portion 11, and a second outer layer portion 12b provided adjacent to the second main surface A of the inner layer portion 11. When it is not necessary to particularly distinguish between the first outer layer portion 12a and the second outer layer portion 12b, they are collectively described as the outer layer portion 12.

In the present example embodiment, the first outer layer portion 12a and the second outer layer portion 12b have different thicknesses, and when the thickness of the first outer layer portion 12a is defined as t1 and the thickness of the second outer layer portion 12b is defined as t2, t2<t1 is satisfied. Here, when mounting the multilayer ceramic capacitor 1 on the land 5 of the mounting substrate, the second outer layer portion 12b is located adjacent to the mounting surface.

Further, in the example embodiments, about 10 μm≤t1≤about 30 μm, and about 0.1≤t2/t1≤about 0.9 are satisfied, for example.

The end surface external electrodes 3 are provided on both end surfaces C of the multilayer body 2. The end surface extension portions 15Ab of the end surface exposed internal electrodes 15A are connected to the end surface external electrodes 3. The end surface external electrodes 3 cover not only the end surfaces C but also portions of the main surfaces A and the lateral surfaces B adjacent to the end surfaces C.

The lateral surface external electrodes 4 are provided on both lateral surfaces B of the multilayer body 2. The lateral surface extension portions 15Bb of the lateral surface exposed internal electrodes 15B are connected to the lateral surface external electrodes 4. The lateral surface external electrodes 4 cover not only the lateral surfaces B but also a portion of the main surfaces A adjacent to the lateral surfaces B.

Each of the end surface external electrodes 3 and each of the lateral surface external electrodes 4 include a base electrode layer 31 and a plated layer 32 provided on the base electrode layer 31. The plated layer 32 includes a Ni (nickel) plated layer 321 provided on the base electrode layer 31 and a Sn (tin) plated layer 322 provided on the Ni plated layer 321. However, example embodiments of the present invention are not limited to such a configuration, and each of the end surface external electrodes 3 and each of the lateral surface external electrodes 4 may have a configuration in which, for example, the base electrode layer 31 is made of Ni, and a Cu plated layer, a Ni plated layer, and a Sn plated layer are sequentially provided thereon.

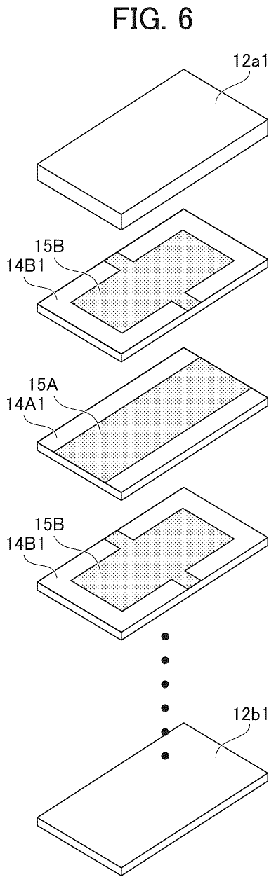

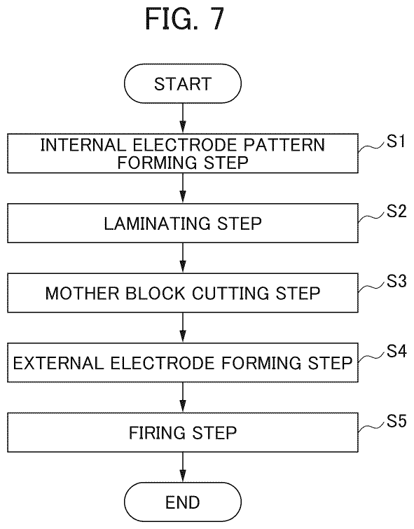

Next, an example of a method of manufacturing the multilayer ceramic capacitors of the example embodiments will be described. FIG. 6 is a diagram explaining the manufacturing steps of the multilayer body 2 in the method of manufacturing the multilayer ceramic capacitor 1. FIG. 7 is a flowchart explaining the method of manufacturing the multilayer ceramic capacitor 1.

The end surface exposed internal electrode 15A is formed on a ceramic green sheet 14A1 functioning as the first dielectric layer 14A using an electrically conductive paste. Similarly, the lateral surface exposed internal electrodes 15B are formed using an electrically conductive paste on ceramic green sheets 14B1 functioning as second dielectric layers 14B.

The ceramic green sheet 14A1 and the ceramic green sheet 14B1 are strip-shaped sheets formed by shaping a ceramic slurry including ceramic powder, a binder, and a solvent into a sheet form on a carrier film using a die coater, gravure coater, micro gravure coater, or the like.

The end surface exposed internal electrodes 15A and the lateral surface exposed internal electrodes 15B are formed by, for example, printing such as screen printing, gravure printing, or relief printing.

The ceramic green sheets 14A1 that function as the first dielectric layers 14A on which the end surface exposed internal electrodes 15A are provided and the ceramic green sheets 14B1 that function as the second dielectric layers 14B on which the lateral surface exposed internal electrodes 15B are provided are alternately laminated.

Subsequently, the ceramic green sheets 12a1 for manufacturing the first outer layer portion 12a and the ceramic green sheets 12b1 for manufacturing the second outer layer portion 12b are provided on the upper and lower sides and thermocompression bonded to form a mother block.

At this time, in the example embodiments, the ceramic green sheet 12a1 for manufacturing the first outer layer portion 12a and the ceramic green sheet 12b1 for manufacturing the second outer layer portion 12b have different thicknesses. The ceramic green sheet 12a1 for manufacturing the first outer layer portion 12a has a thickness of t1 after firing, and the ceramic green sheet 12b1 for manufacturing the second outer layer portion 12b is made of the same material as the ceramic green sheet 12a1 for manufacturing the first outer layer portion 12a but has a different thickness, and has a thickness after firing of t2, which is thinner than t1. Furthermore, t1 has a thickness such that about 10 μm≤t1≤about 30 μm and about 0.1≤t2/t1≤about 0.9, for example.

However, example embodiments of the present invention are not limited thereto, and it is possible to use the ceramic green sheet 12b1 for manufacturing the second outer layer portion 12b that has a lower inorganic component ratio than the ceramic green sheet 12a1 for manufacturing the first outer layer portion 12a. In this case, even when the ceramic green sheet 12a1 for manufacturing the first outer layer portion 12a and the ceramic green sheet 12b1 for manufacturing the second outer layer portion 12b have the same thickness, the shrinkage rate during firing is greater for the second outer layer portion 12b, so it is possible to make the second outer layer portion 12b thinner than the first outer layer portion 12a after firing.

As another method, it is possible to use the ceramic green sheet 12b1 for manufacturing the second outer layer portion 12b that is made of the same material and has the same thickness as the ceramic green sheet 12a1 for manufacturing the first outer layer portion 12a, provide an additional firing step before forming the external electrodes, and polish the second outer layer portion 12b after firing to make the second outer layer portion 12b thinner than the first outer layer portion 12a.

Next, the mother block is cut and divided in the length direction L and the width direction W to manufacture a plurality of rectangular parallelepiped multilayer bodies 2.

Next, the lateral surface external electrodes 4 are formed on both lateral surfaces B of the multilayer body 2. The lateral surface extension portions 15Bb of the lateral surface exposed internal electrodes 15B are connected to the lateral surface external electrodes 4. The lateral surface external electrodes 4 are formed to cover not only the lateral surfaces B but also portions of the main surfaces A adjacent to the lateral surfaces B.

Then, end surface external electrodes 3 are formed on both end surfaces C of the multilayer body 2. The end surface extension portions 15Ab of the end surface exposed internal electrodes 15A are connected to the end surface external electrodes 3. The end surface external electrodes 3 are formed to cover not only the end surfaces C but also portions of the main surfaces A and portions of lateral surfaces B adjacent to the end surfaces C.

Then, heating is performed for a predetermined time in a nitrogen atmosphere at a set firing temperature. Thus, the end surface external electrodes 3 and the lateral surface external electrodes 4 are fired on the multilayer body 2 to manufacture the multilayer ceramic capacitor 1 shown in FIG. 1.

The multilayer ceramic capacitors 1 manufactured in this manner are each accommodated in a corresponding one of a plurality of storage recesses provided in a carrier tape when transported. The opening of the storage portion is then covered with a top tape, and the multilayer ceramic capacitors 1 are transported in the form of packaging tape.

When accommodating the multilayer ceramic capacitors 1 in the storage recesses of the carrier tape, it is preferable that all the multilayer ceramic capacitors 1 are accommodated with the same orientation. Therefore, for example, during accommodation, the multilayer ceramic capacitors 1 are placed in a magnetic field. As a result, the magnetic flux amount differs between the first outer layer portion 12a and the second outer layer portion 12b. By sorting the orientation of the multilayer ceramic capacitors 1 in the lamination direction T based on this difference in magnetic flux amount, it is possible to accommodate the multilayer ceramic capacitors 1 in the storage portions in a fixed orientation.

Alternatively, since the first outer layer portion 12a and the second outer layer portion 12b have different thicknesses, the color shading differs. The orientation of the multilayer ceramic capacitor 1 in the lamination direction T can also be sorted based on this difference in shading.

Furthermore, in order to indicate that the second outer layer portion 12b, which is thinner than the first outer layer portion 12a, corresponds to the mounting surface, for example, the letter “m” may be printed on the main surface A on the second outer layer portion 12b to indicate that the second outer layer portion 12b corresponds to the mounting side.

In addition, since the second outer layer portion 12b, which is the mounting surface, is thinner than the first outer layer portion 12a, the corner portions are more angular than those of the first outer layer portion 12a. Therefore, the second outer layer portion 12b, which is the mounting surface, may be identified based on this difference in corner roundness.

The multilayer ceramic capacitor 1 is mounted on a substrate, for example, as follows. First, the top tape is peeled while moving the carrier tape in one direction. In this state, the multilayer ceramic capacitor 1 in the storage recess of the carrier tape is taken out by a mounter nozzle and mounted via solder on the land 5 (shown in FIG. 1) made of electrically conductive material formed on the surface of the substrate. At this time, the second outer layer portion 12b functions as the mounting surface for the substrate.

Here, when the thickness of the first outer layer portion 12a is t1<about 10 μm, for example, the multilayer ceramic capacitor 1 may be damaged by the impact during placement on the land 5 by the mounter nozzle. However, in the example embodiments, since about 10 μm≤t1 is satisfied, for example, the multilayer ceramic capacitor 1 is less likely to be damaged by this impact. Further, when the thickness of the first outer layer portion 12a is about 30 μm<t1, for example, the region of the inner layer portion 11 becomes narrow and the capacitance of the multilayer ceramic capacitor 1 becomes small, which is not preferred. However, in the example embodiments, since t1≤about 30 μm is satisfied, for example, the region of the inner layer portion 11 does not become narrower than necessary.

Electric current flows from the substrate through the end surface external electrode 3 to the end surface exposed internal electrode 15A (through electrode) of the multilayer ceramic capacitor 1 provided on the substrate in this manner, such that electric charge is accumulated. In the present example embodiment, the first outer layer portion 12a and the second outer layer portion 12b have different thicknesses, and when the thickness of the first outer layer portion 12a is defined as t1 and the thickness of the second outer layer portion 12b is defined as t2, t2<t1 is satisfied, and when the multilayer ceramic capacitor 1 is mounted on the lands 5 of the mounting substrate, the second outer layer portion 12b corresponds to the mounting surface.

That is, in the multilayer ceramic capacitor 1, the second outer layer portion 12b functioning as the mounting surface is thin. Therefore, the length in the lamination direction T of the end surface external electrode 3 on the end surface of the second outer layer portion 12b also becomes short. Consequently, the path of electric current flowing from the substrate to the end surface exposed internal electrode 15A becomes short. For this reason, it is possible to reduce the ESL of the multilayer ceramic capacitor 1.

The thickness t1 of the first outer layer portion 12a is about 10 μm≤t1≤about 30 μm, for example.

Unlike the example embodiments, when the thickness t1 of the first outer layer portion 12a is t1<about 10 μm, there is a possibility that the multilayer ceramic capacitor 1 cannot withstand the impact when the multilayer ceramic capacitor 1 is adsorbed by a mounter nozzle and arranged on the land 5 during mounting on the mounting substrate. However, in the example embodiments, since about 10 μm≤t1 is satisfied, for example, the multilayer ceramic capacitor 1 has strength that can withstand the impact during mounting.

When the thickness t1 of the first outer layer portion 12a is about 30 μm<t1, in the multilayer body 2 having the dimension TL in the lamination direction T of about 0.54 mm or less, the first outer layer portion 12a becomes thick and the inner layer portion 11 becomes relatively thin. However, in the example embodiments, since t1≤about 30 μm is satisfied, for example, it is possible to sufficiently secure the thickness of the inner layer portion 11.

The ratio of the thickness t2 of the second outer layer portion 12b to the thickness t1 of the first outer layer portion 12a is about 0.1≤t2/t1≤about 0.9, for example. Unlike the example embodiments, when about 0.9<t2/t1 is satisfied, the ESL improvement effect becomes small. However, in the example embodiments, since t2/t1≤about 0.9 is satisfied, for example, it is possible to obtain a sufficient ESL improvement effect.

When t2/t1<about 0.1 is satisfied, uniform formation of the second outer layer portion 12b becomes difficult. However, in the example embodiments, since about 0.1≤t2/t1 is satisfied, for example, it is possible to form the second outer layer portion 12b uniformly.

Although example embodiments of the present invention have been described above, the present invention is not limited to the above-described example embodiments, and various changes and modifications thereto can be made.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including an inner layer portion including a plurality of dielectric layers and a plurality of internal electrodes that are alternately laminated, and a first outer layer portion provided on one side in the lamination direction of the inner layer portion and a second outer layer portion provided on the other side in the lamination direction of the inner layer portion;
end surface external electrodes each provided on a corresponding one of both end surfaces in the length direction intersecting with the lamination direction of the multilayer body; and
a lateral surface external electrode provided on at least one of lateral surfaces in the width direction intersecting with the lamination direction and the length direction of the multilayer body; wherein
a dimension LC in the length direction is about 0.1 mm≤LC≤about 0.70 mm or less;
a dimension WC in the width direction is about 0.05 mm≤WC≤about 0.40 mm or less; and
a dimension TC in the lamination direction is about 0.10 mm≤TC≤about 0.55 mm or less;
the second outer layer portion corresponds to a mounting surface; and
when the thickness of the first outer layer portion is defined as t1 and the thickness of the second outer layer portion is defined as t2, t2<t1 is satisfied.

2. The multilayer ceramic capacitor according to claim 1, wherein about 10 μm≤t1≤about 30 μm, and about 0.1 ≤t2/t1≤about 0.9 are satisfied.

3. The multilayer ceramic capacitor according to claim 1, wherein the multilayer ceramic capacitor has a capacitance of about 0.022 μF or more and about 10 μF or less.

4. The multilayer ceramic capacitor according to claim 1, wherein an equivalent series inductance is about 65 pH or less at about 100 MHz and about 50 pH or less at about 1 GHz.

5. The multilayer ceramic capacitor according to claim 1, wherein a capacitance is about 1.0 μF or more and about 2.2 μF or less.

6. The multilayer ceramic capacitor according to claim 1, wherein the multilayer body includes rounded corner portions and ridge portions.

7. The multilayer ceramic capacitor according to claim 1, wherein the multilayer body includes dimensions of about 0.09 mm or more and about 0.69 mm or less in the length direction, about 0.04 mm or more and about 0.39 mm or less in the width direction, and about 0.09 mm or more and about 0.54 mm or less in the lamination direction.

8. The multilayer ceramic capacitor according to claim 1, wherein the plurality of dielectric layers include ceramic material.

9. The multilayer ceramic capacitor according to claim 8, wherein the ceramic material includes at least one of Ca, Zr, or Ti.

10. The multilayer ceramic capacitor according to claim 8, wherein the ceramic material has a perovskite structure including Ca and Zr.

11. The multilayer ceramic capacitor according to claim 8, wherein the ceramic material includes barium titanate and calcium zirconate.

12. The multilayer ceramic capacitor according to claim 8, wherein the ceramic material includes Ca, Zr, and Ti.

13. The multilayer ceramic capacitor according to claim 1, wherein the plurality of internal electrodes include Ni, Cu, Ag, Pd, an Ag—Pd alloy, or Au.

14. The multilayer ceramic capacitor according to claim 1, wherein each of the end surface external electrodes and the lateral surface external electrode includes a base electrode layer and a plated layer.

15. The multilayer ceramic capacitor according to claim 14, wherein the plated layer includes a Ni plated layer and a Sn plated layer.

16. The multilayer ceramic capacitor according to claim 1, wherein each of the end surface external electrodes and the lateral surface external electrode includes a base electrode layer made of Ni, a Cu plated layer, a Ni plated layer, and a Sn plated layer.

17. The multilayer ceramic capacitor according to claim 1, wherein the second outer layer portion includes a main surface including a mark to indicate that the main surface is the mounting surface.

18. The multilayer ceramic capacitor according to claim 1, wherein the second outer layer portion includes corner portions that are more angular than corner portions of the first outer layer portion.

19. An electronic component apparatus comprising:
a mounting substrate; and
the multilayer ceramic capacitor according to claim 1 mounted on the mounting substrate such that the second outer layer portion is mounted to a surface of the mounting substrate.

20. The electronic component apparatus according to claim 19, wherein about 10 μm≤t1≤about 30 μm, and about 0.1≤t2/t1≤about 0.9 are satisfied.
